(19) United States
(12) Patent Application Publication
(10) Pub. No.: US 2025/0096884 A1
(43) Pub. Date: Mar. 20, 2025

(54) VISUAL ALIGNMENT OF PAIRED ELECTRONIC APPLIANCES

(71) Applicant: T-Mobile USA, Inc., Bellevue, WA (US)

(72) Inventor: Chad Au, Kirkland, WA (US)

(21) Appl. No.: 18/469,180

(22) Filed: Sep. 18, 2023

(51) Int. Cl. H04B 7/155; H04B 10/035

(52) U.S. Cl. CPC H04B 7/15528; H04B 10/035

(57) ABSTRACT

Described herein are techniques for aligning two units of an electronic appliance. An electronic appliance may a first unit configured to couple to a first side of a transparent material, the first unit comprising: an optical loopback component, the optical loopback component comprising at least a loopback input, a loopback output, and a light redirection component; and a second unit configured to couple to a second side of the transparent material, the second unit comprising: a first directional light source, wherein the first directional light source is aligned with the loopback input when the second unit is properly aligned with the first unit; and a first viewing aperture, wherein the first viewing aperture is aligned with the loopback output when the second unit is properly aligned with the first unit.

### BACKGROUND

As the modern world continues to rely on consumer devices that operate via a wireless connection, adaptations and improvements are being made to the appliances that transmit the radio frequency (“RF”) waves carrying user information. RF waves suffer significant quality degradation as they propagate into indoor spaces to reach users that are using user devices within those spaces. As a result, the user experience can become severely limited, or at worst, nonexistent.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 is an example block diagram of an architecture for a window mounted wireless gateway system according to some implementations.

FIG. 2 is a perspective view of a wireless gateway system mounted on a transparent material in accordance with some embodiments.

FIG. 3 is another example block diagram of an architecture for a window mounted wireless (Wi-Fi) gateway system according to some implementations.

FIG. 4 is a first example block diagram of an architecture for a window mounted wireless gateway system according to some implementations.

FIG. 5 is a second example block diagram of an architecture for a window mounted wireless gateway system according to some implementations.

FIG. 6 is a third example block diagram of an architecture for a window-mounted wireless gateway system according to some implementations.

FIG. 7 is a flow diagram illustrating an example process associated with aligning two units mounted on each side of a transparent material.

### DETAILED DESCRIPTION

### Overview

In embodiments, a class of appliances may be configured to circumvent RF signal degradation by converting user data from RF waves into optical medium for transmission through the glass of windows and then into a second format to be conveyed over a local network connection. An example of one such appliance is described in co-pending U.S. patent application Ser. No. 18/232,486, which is expressly incorporated herein by reference in its entirety. Such appliances (e.g., wireless (Wi-Fi) gateway systems) may include two paired units, each of which are installed on opposite sides of a transparent material (e.g., a window). In such systems, alignment of the two units is imperative to achieve proper installation and full functionality.

This disclosure is directed to a visual alignment feature that can be used to verify the alignment of two units of a wireless gateway system, where the first unit is not directly powered and is mounted on one surface (e.g., an exterior surface) of a transparent material and where the second unit is powered and mounted on the other surface (e.g., an interior surface) of the transparent material directly opposite to the first unit. An example of the transparent material may be a glass window, where the first unit is mounted on the outside surface of the window and the second unit is mounted on the inside surface of the window and electronically connected to an inside power source (e.g., a household AC power supply).

The visual alignment feature may include an optical loopback component that redirects light from a directional light source into a viewing aperture when the two units are properly aligned. The optical loopback component may be situated in the first unit, where a loopback input to the optical loopback component is aligned with the directional light source situated in the second unit and a loopback output to the optical loopback component is aligned with the viewing aperture also situated in the second unit. The viewing aperture may provide a viewing channel between a first side of the second unit and a second side of the second unit opposite the first side.

An example of the directional light source may be a light-emitting diode (LED). The optical loopback component may be of any material or object that redirects light, including fiber optic tubes, reflective surfaces, prisms, or lenses. An example of the optical loopback component may be an optical waveguide loopback, such as a fiber optic tube bent into a U-shape so that light may enter one end, travel through the tube, and exit out the other end. Another example of the optical loopback component may be an optical mirror loopback, such as a series of mirrors that reflect and redirect light. Another example of the optical loopback component may be a prism tile, panel, or film that bends or refracts incoming light and redirects it. Another example of the optical loopback component may be a lens, such as a condenser. A condenser is an optical lens which renders a divergent light beam from a point light source into a parallel or converging beam to illuminate an object to be imaged.

Light from the directional light source that is redirected through the optical loopback component into the viewing aperture may be observable by a user situated at the viewing aperture. Such redirected light is observable by the user when the two wireless gateway system units are aligned. If the first and second units are not properly aligned, light from at least one directional light source may not align with the loopback input opening to the optical loopback component and none or very little of the light will propagate through the optical loopback component from one end to the other. When not enough light propagates through the optical loopback component, the user will not observe any light from the viewing aperture.

To ensure proper alignment of the two units, more than one directional light source and viewing aperture may be implemented at strategic locations in the appliance to prevent either unit from being mounted up-side-down, in a reversed orientation, or off kilter. In embodiments, each of the directional light sources may be located on opposite sides (or corners) of the two units. In embodiments that include two light sources, the two units are considered aligned only once the two light sources can each be viewed via their respective viewing aperture.

Embodiments provide advantages over conventional systems. As the RF waves propagate into indoor spaces to reach users of consumer devices that rely on a wireless connection, those RF waves suffer significant quality degradation. In embodiments, the properly aligned units of the appliance (e.g., a wireless gateway system) may circumvent any attenuation of signals that limit user experience. A wireless modem in one of the units may decode the RF waves into optical signals and a wireless router in the other unit may then convert them into Wi-Fi signals. Once the two units are aligned, optical signals may be transmitted from one unit to another via optical couplers in each unit. Even where a transparent material exists between the two wireless gateway units, user data carried in RF waves may still be transmitted across the transparent material without quality degradation.

Another advantage is that power may be provided to devices on only one side of a transparent material. The first wireless gateway unit that is coupled to a power source may include a first power supply to store power from the power source and a wireless power transmitter to output a wireless charging signal. The second unit that is not coupled directly to a power source may include a wireless power receiver configured to capture power from the wireless charging signal transmitted by the first unit and a second power supply (e.g., a battery) to store the power from the wireless power receiver. This alleviates the need for a power source for the second unit.

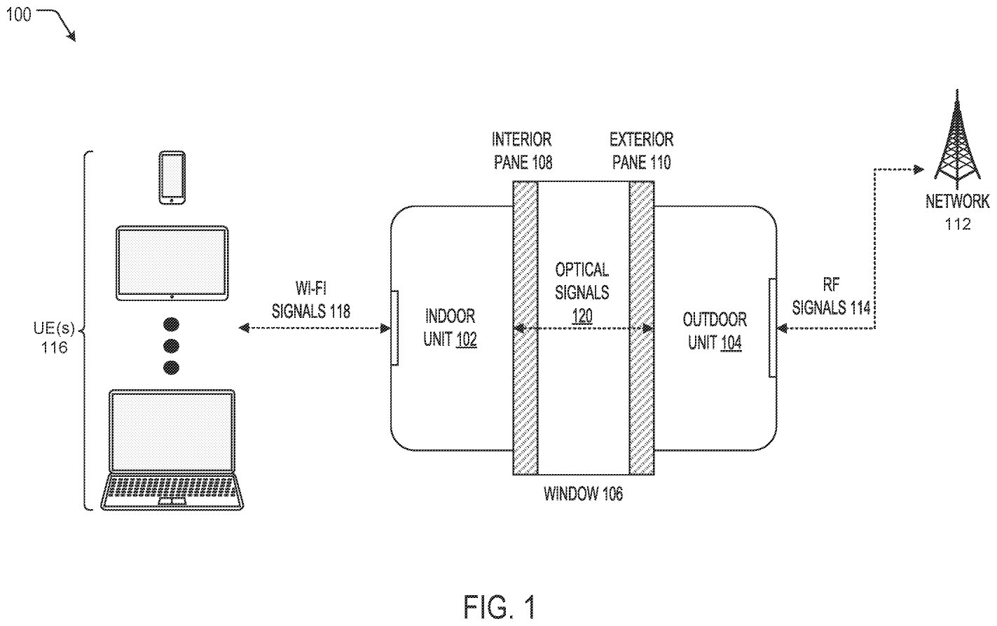

FIG. 1 is an example block diagram of an architecture for a window mounted wireless gateway system 100 according to some implementations. In the current example, the window mounted Wi-Fi gateway system 100 includes an indoor unit 102 and an outdoor unit 104. The indoor unit 102 and the outdoor unit 104 may be aligned on opposing sides (e.g., the interior and exterior, respectively) of a window 106 having one or more panes of glass, such as an interior pane 108 and an exterior pane 110 illustrated in the current example. The alignment may be configured such that one or more transmitters operating in multiple frequency bands of the indoor unit 102 align with one or more receivers of the outdoor unit 104 and one or more receivers of the indoor unit 102 align with one or more transmitters of the outdoor unit 104. For instance, an optical receiver of the indoor unit 102 may align with an optical transmitter of the outdoor unit 104 and an optical receiver of the outdoor unit 104 may align with an optical transmitter of the indoor unit 102.

In the current example, the outdoor unit 104 may be in wireless communication with a network 112, such as a mobile network providing high speed wireless internet services to an end-user. In this manner, the outdoor unit 104 may be configured to receive incoming data via RF signals 114 received from the network 112 and to transmit outgoing data via RF signals 114 sent to the network 112. Likewise, the indoor unit 102 may be in wireless communication with one or more user equipment (UE) 116, such as smart phones, televisions, smart appliances, tablets, personal computers, and the like associated with the end-user. In this manner, the indoor unit 102 may be configured to receive outgoing data via wireless signals 118 received from the UE 116 and to transmit incoming data via wireless signals 118 sent to the UE 116. In addition, the outdoor unit 104 may be in wireless communication with the indoor unit 102. In this manner, the outdoor unit 104 may be configured to receive incoming data via optical signals 120 received from the indoor unit 102 and to transmit outgoing data via optical signals 120 sent to the indoor unit 102. Likewise, the indoor unit 102 may be configured to receive incoming data via optical signals 120 received from the outdoor unit 104 and to transmit outgoing data via optical signals 120 sent to the outdoor unit 104.

In some cases, the alignment between the indoor unit 102 and the outdoor unit 104 may be configured to accommodate one or more coatings applied to the window 106 (e.g., a low-energy coating, tint, argon gas layer, or the like). In this manner, the system 100 may be configured to provide an installation or set-up assistant, such as via a paired downloadable application on a UE 116. For instance, as one illustrative example, a user may apply or adhere the exterior unit 104 to an exterior of a window 106 of their home environment. The user may also download an application to the UE 116. The user may also pair the application hosted on the UE 116 to the interior unit 102 (such as over a home network, Bluetooth, or the like).

In some embodiments, the application may then present an alignment graphic or interface on a display of the UE 116 that may assist with aligning the indoor unit 102 with the exterior unit 104. For example, the interface may include a cursor or pointer that represents the interior unit 102 that may move on the interface as the user moves the indoor unit 102. The interface may also present a target that represents the exterior unit 104. In this manner, the user may move the cursor to the target by moving the indoor unit 102 with respect to the window 106 and the outdoor unit 104. The interface may, upon proper alignment (e.g., signal received and/or sent between the indoor unit 102 with the exterior unit 104 greater than one or more thresholds), display an aligned indicator (such as a green indicator) to inform the user to adhere the indoor unit 102 to the window 106 at the current alignment. In this manner, the system 100 may accommodate alignment that may be more complicated than aligning the exteriors of the two units 102 and 104, such as caused by any optical transmission interference that occurs due to coatings, gasses, tinting and the like.

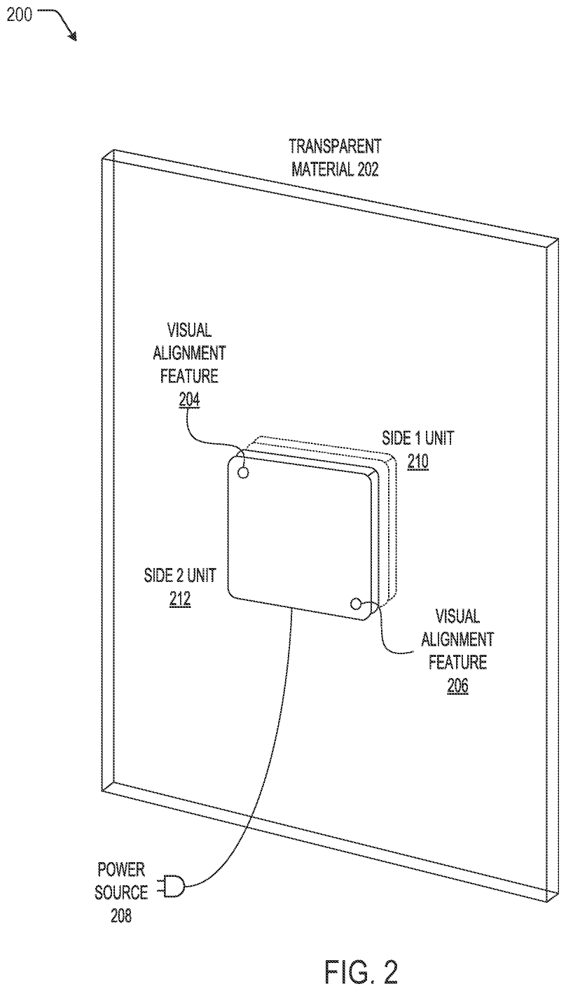

FIG. 2 is a perspective view of a wireless gateway system 200 mounted on a transparent material 202 in accordance with some embodiments. The system may include one unit 210 on side 1 of the transparent material and a second unit 212 on side 2 of the transparent material. Visual alignment features 204 and 206 that extend into both units may be situated on opposing corners. A power source 208 may be coupled to unit 212.

As depicted, the second unit 212 may be powered using a power source 208, which may be a source of external AC (alternating-current) power, such as a household AC power supply (alternatively referred to herein as “AC mains” or “wall power”). The AC power may have a voltage in the range of 112-224 VAC, for example. The incoming AC power may be received by an AC/DC adapter (not shown), which may convert the incoming AC power to DC (direct-current) and may step down the voltage from 112-224 VAC to a lower output voltage of about 12 V DC and an output current of about 2 A, for example. In various embodiments, the output of the AC/DC adapter is in a range from about 3 V to about 15 V and in a range from about 0.5 A to about 5 A. These voltages and currents are examples provided for illustration and are not intended to be limiting.

Each of the unit 210 and the second unit 212 may be secured to the transparent material using any suitable means. For example, each of the units may be fitted with a suction cup that, when an appropriate amount of pressure is applied to the respective unit, secures that unit to the transparent material.

The visual alignment features 204 and 206 may be located in any suitable location. In some cases, the visual alignment features may be located in opposite corners of the indoor unit as depicted. In other cases, the visual alignment features may be vertically or horizontally aligned.

It should be noted that while the transparent material is frequently discussed as being glass, one skilled in the art would recognize that other suitable transparent materials could be equivalently used. By way of non-limiting example, the material may be soda-lime-silicate glass, polycarbonate material, acrylic material, or any other suitable transparent material. It should be noted that because the information transmitted between the two units is in optical form, the device described herein would be capable of working even with transparent materials that significantly reduce, or even block, RF waves.

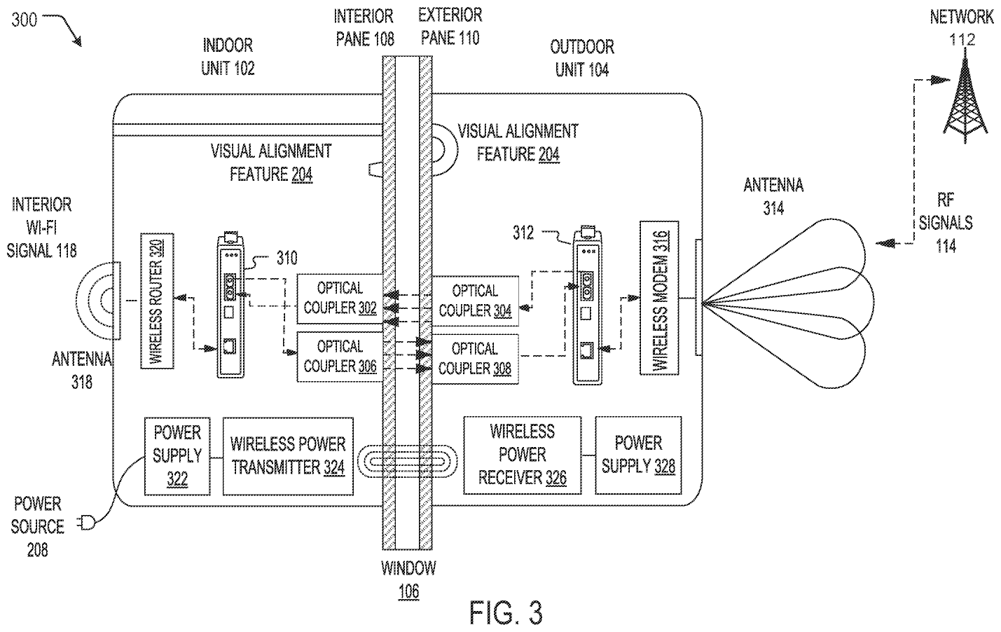

FIG. 3 is another example block diagram of an architecture for a window mounted wireless (Wi-Fi) gateway system 300 according to some implementations. In the current example, the window mounted Wi-Fi gateway system 300, again, includes the indoor unit 102 and the outdoor unit 104. As discussed above, the indoor unit 102 and the outdoor unit 104 may be aligned (as discussed above with respect to FIG. 1) and secured on opposing sides (e.g., the interior and exterior, respectively) of the window 106 having one or more panes of glass (such as the interior pane 108 and the exterior pane 110 illustrated in the current example).

The alignment may be configured such that a first optical coupler 302 (or transducer, collimator, or the like) of the indoor unit 102 aligns with a first optical coupler 304 (or transducer, collimator, or the like) of the exterior unit 104, such that data may be transmitted from the first optical coupler 304 of the exterior unit 104 to the first optical coupler 302 of the indoor unit 102. Likewise, a second optical coupler 306 of the indoor unit 102 aligns with a second optical coupler 308 of the exterior unit 104, such that data may be transmitted from the second optical coupler 306 of the indoor unit 102 to the second optical coupler 308 of the exterior unit 104. For instance, the optical couplers 304 and 306 may output the data as an optical-based signal that may be received by the optical couplers 302 and 308, respectively.

The outdoor unit 104 may also include one or more antenna 314 positioned with respect to an antenna aperture. The antennas 314 may be coupled to a wireless modem 316. The wireless modem 316 may be configured to decode the RF signals received by the antennas 314 from one or more networks, such as network 112 of FIG. 1. The wireless modem 316 may be in electronic communication with the optical couplers 304 and 308. In the current example, the antenna 314 may be a beam forming antenna that may direct the coverage of the system 300 in a desired direction or configuration with respect to the network 112.

In the current example, the antennas 314 may be configured to provide beam forming to improve signal reception and/or transmission with respect to omnidirectional antenna responses and the RF signals 114. In some cases, the antennas 314 may include multiple antennas that are configured to have adjustable phase and amplitude to generate beam or focused area of coverage. In the focused area of coverage, the antennas 314 may provide increased signal strength and/or range, improved signal quality, and otherwise enhanced network capabilities. In these examples, the antennas 314 may be adjusted to have a beam shaped in the direction of a nearest proximate cellular tower or the like.

The indoor unit 102 may include one or more antenna 318 positioned with respect to an antenna aperture. The antennas 318 may be coupled to a wireless router 320. The wireless router 320 of the indoor unit 102 may be configured to decode the interior Wi-Fi signals 118 received by the antennas 318 from, for instance, a UE within the interior environment. The wireless router 320 may be in electronic communication with the optical couplers 302 and 306.

In the current example, the indoor unit 102 may include a converter 310 (such as a media converter or the like) to decode and/or translate data transmission signals from a first type to a second type. For example, the converter 310 may receive Wi-Fi signals 118 (used to convey data such as media files) and convert those signals to a format that can be used by signals (such as representative of media files) received from the optical coupler 302 in generating an optical data signal. In other words, the converter 310 is configured to convert a signal from one medium (e.g., an Ethernet signal) into a second medium (e.g., an optical signal). Likewise, the outdoor unit 104 may include a converter 312 configured to decode and/or translate signals received from the optical coupler 308 into another medium (e.g., Ethernet signals).

As discussed with respect to FIG. 1 above, the indoor unit 102 may also include a power supply 322 that may be coupled to a power source 208 (such as an outlet in the interior environment). The power supply 322 may provide power to the indoor unit 102 and act as a power source for the outdoor unit 104. For instance, the power supply 322 may be coupled to a wireless power transmitter 324 to output a power signal such as an inductive power supply signal.

The outdoor unit 104 may be equipped with a wireless power receiver 326 that may be configured to capture power from the inductive power supply signal. The wireless power receiver 326 may be coupled to a power supply 328 of the outdoor unit 104. In some cases, the power supply 328 may include a power storage means, such as a battery or capacitor. The power supply 328 may be charged with power received via the wireless power receiver 326. The outdoor unit 104 may draw power from the power supply 328 when no power is being received via the power signal.

As noted elsewhere, one or more components of the indoor unit 102 and the outdoor unit 104 may require proper alignment in order to function properly. For example, in order for a power signal to be received at the outdoor unit 104 (and for that unit to be powered), the wireless power transmitter 324 of the indoor unit 102 may need to be aligned with the wireless power receiver 326 of the outdoor unit. In another example, in order for information to be transmitted between the optical couplers 302-308, they may need to be properly aligned. In some cases, even a small misalignment may result in data loss or lag.

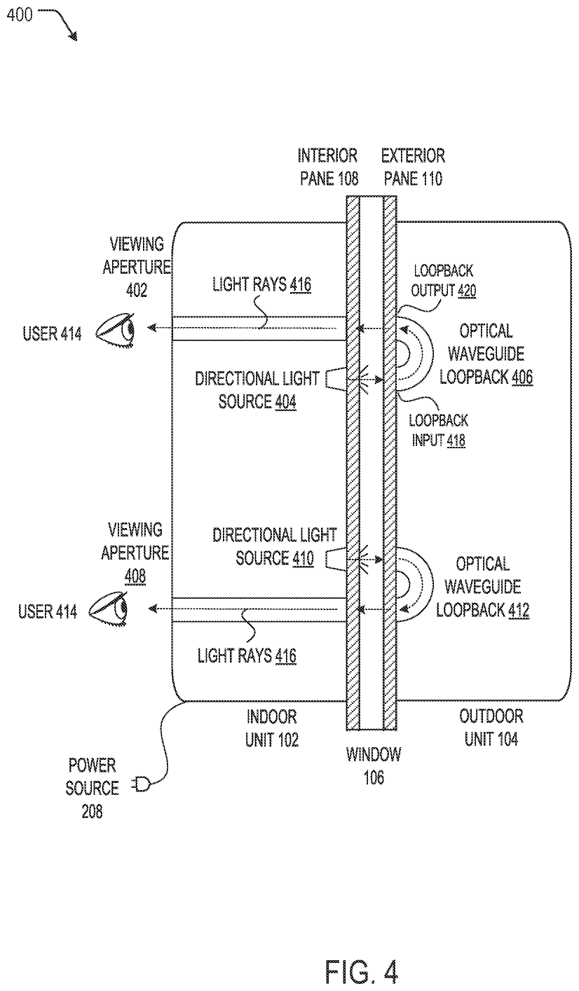

FIG. 4 is a first example block diagram of an architecture for a window mounted wireless gateway system 400 according to some implementations. Light rays 416 from a directional light source 404 may enter an optical waveguide loopback 406 that in turn redirects the light rays 416 into a viewing aperture 402. The light rays may enter the optical waveguide loopback 406 at a loopback input 418 and exit at a loopback output 420. The redirected light may be observed by a user 414 when indoor unit 102 and outdoor unit 104 are properly aligned. If the indoor unit 102 and outdoor unit 104 are not properly aligned, none or little of the light will be redirected through the optical waveguide loopback 406 from one end to the other. If the not enough light is redirected through the optical waveguide loopback 406, the light may not be observable by user 414 from the viewing aperture 402.

To ensure proper alignment of the two units, more than one directional light source and viewing aperture may be implemented at strategic locations in the appliance to prevent either unit from being mounted up-side-down or in a reversed orientation. According to some implementations, there may be a second directional light source 410 and a second viewing aperture 408 situated in the indoor unit 102, diagonally opposite of the directional light source 404 and viewing aperture 402. According to some implementations, there may be a second optical waveguide loopback 412 situated in the outdoor unit 104, diagonally opposite of the optical waveguide loopback 406.

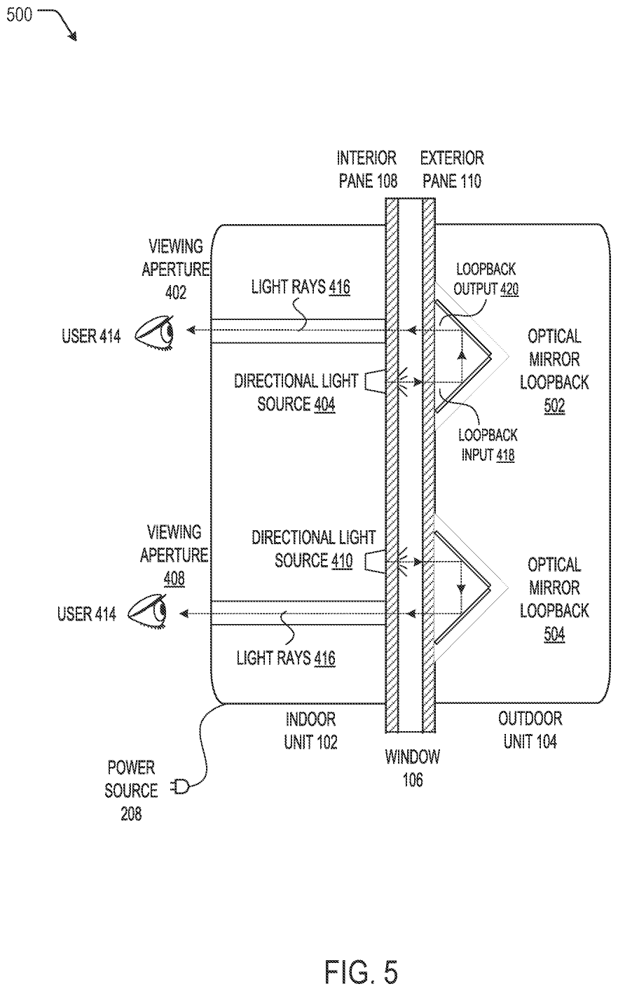

FIG. 5 is a second example block diagram of an architecture for a window mounted wireless gateway system 500 according to some implementations. Light rays 416 from directional light source 404 may reflect onto an optical mirror loopback 502 that in turn reflects and redirects the light rays 416 into viewing aperture 402. The light rays may enter the optical mirror loopback 502 at a loopback input 418 and exit at a loopback output 420. The redirected light may be observed by a user 414 when indoor unit 102 and outdoor unit 104 are properly aligned. If the indoor unit 102 and outdoor unit 104 are not properly aligned, none or little of the light will be redirected by the optical mirror loopback 502 from one end to the other. If the not enough light is redirected by the optical mirror loopback 502, the light may not be observable by user 414 from the viewing aperture 402.

To ensure proper alignment of the two units, more than one directional light source and viewing aperture may be implemented at strategic locations in the appliance to prevent either unit from being mounted up-side-down or in a reversed orientation. According to some implementations, there may be a second directional light source 410 and a second viewing aperture 408 situated in the indoor unit 102, diagonally opposite of the directional light source 404 and viewing aperture 402. According to some implementations, there may be a second optical mirror loopback 504 situated in the outdoor unit 104, diagonally opposite of the optical mirror loopback 502.

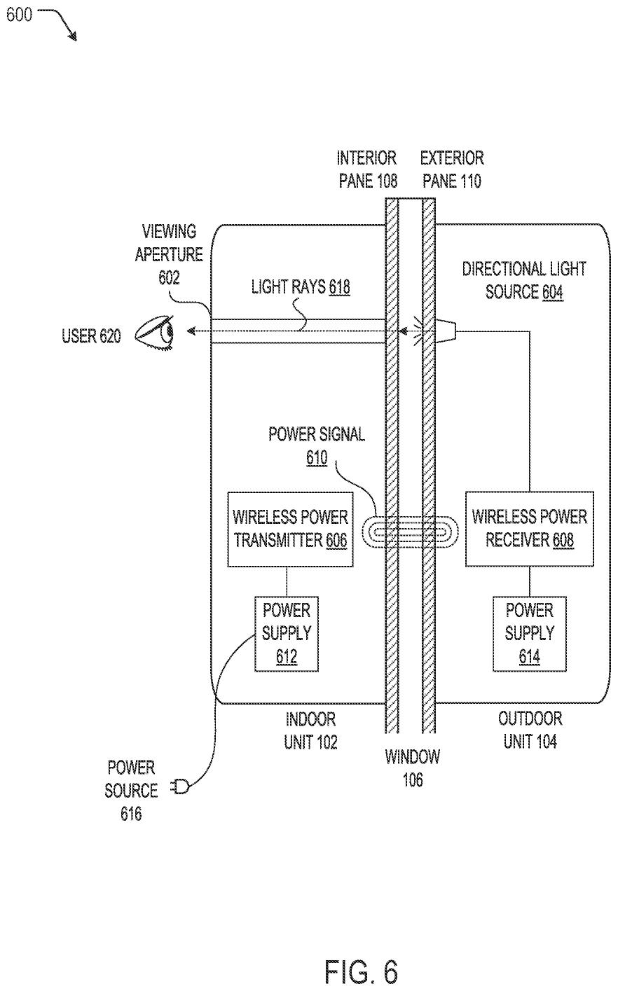

FIG. 6 is a third example block diagram of an architecture for a window-mounted wireless gateway system according to some implementations. In this third example, the viewing aperture 602 may be included in the indoor unit 102 similarly to the other examples described above. However, the outdoor unit 104 may include the directional light source 604.

It would be recognized by one skilled in the art that the outdoor unit 104, lacking a direct power source, would be unable to power the directional light source 604 without access to a power signal. However, in embodiments, when an indoor unit 102 is brought into tentative alignment with the outdoor unit 104, a wireless power transmitter 606 included in the indoor unit 102 may be brought into relative alignment with a wireless power receiver 608 included in the outdoor unit 104. The wireless power transmitter 606 may continue to transmit a power signal 610 across the window to the outside unit 104. As described elsewhere, each of the wireless power components 606 and 608 may be in communication with a respective power supply 612 and 614. Additionally, the power supply 614 may draw power from a power source 208, such as a household outlet.

While the wireless power transmitter 606 of the indoor unit 102 is not completely aligned with the wireless power receiver 608 of the outdoor unit 104, as long as the two components are at least partially aligned, the wireless power receiver 608 may receive enough power via the power signal 610 to power the directional light source 604. In some embodiments, such a light source 604 may be selected for inclusion in the example architecture because of its low power requirements.

Once the indoor unit 102 and outdoor unit 104 have been at least partially aligned, the directional light source 604 may be powered to produce light rays 618. In some cases, a light level produced by the directional light may correspond to a degree of alignment. For example, the directional light source 604 may produce more light as the two units become more aligned. In some embodiments, the directional light source 604 may be configured to indicate perfect (or near-perfect) alignment. For example, the directional light source may change the color of light that it produces once a threshold amount of power is detected as being received via the power signal 610. The user may continue to adjust the indoor unit (e.g., by moving the unit or rotating it) until the light rays 618 are visible through the viewing aperture.

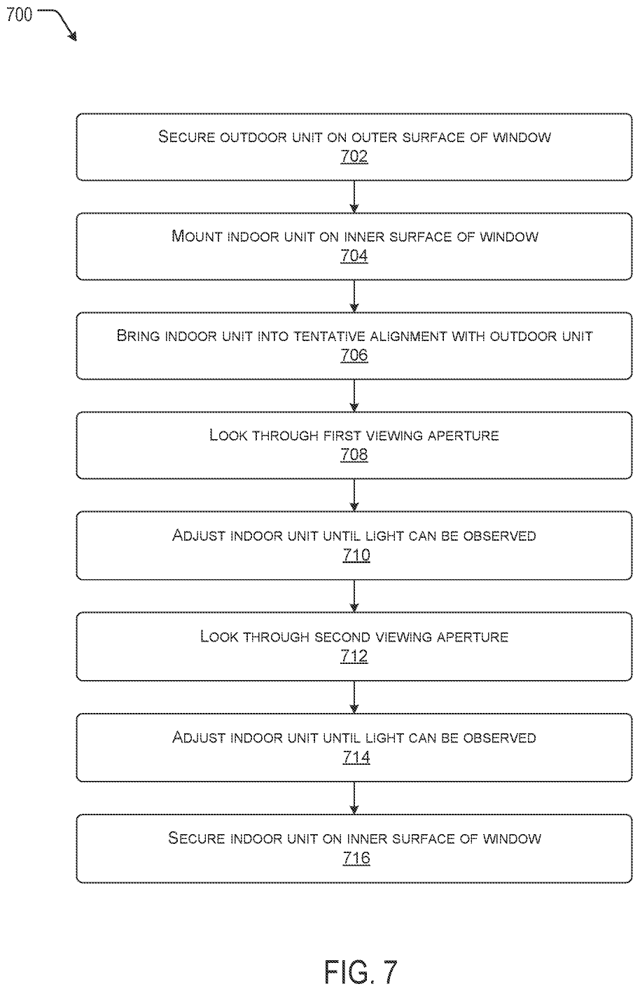

FIG. 7 is a flow diagram illustrating an example process 700 associated with aligning two units mounted on each side of a transparent material. For example, indoor and outdoor units of a window mounted appliance (e.g., a wireless gateway) may be aligned prior to use, such that the optical signal transmitted from one unit to the other may be received with a threshold level of reliability and the wireless power signal may be adequately enabled to charge and power the outdoor unit during use.

At 702 of the process 700, a user may first secure the outdoor unit to the outside of a window. For example, the user may place the outdoor unit of the appliance in a corner of the window so as to prevent obstruction of a view through the window. As noted elsewhere, the outdoor unit may be secured to the window via any suitable securing means, such as a suction cup or adhesive pad. In such cases, the user may position the outdoor unit next to the window and then apply pressure to the outdoor unit in order to secure the outdoor unit to the window. In some cases, one or more markings included on the outdoor unit may indicate a position and/or pose in which the outdoor unit should be secured to the window.

At 704, once the outdoor unit has been secured to the outside of the window, the user may mount the indoor unit on the inner surface of the window. To do this, the user may place the indoor unit up against the window opposite the outside unit. In some cases, one or more markings included on the indoor unit may indicate a position and/or pose in which the indoor unit should be secured to the window.

At 706, the indoor unit may be brought into tentative alignment with the outdoor unit. For example, in addition to being positioned opposite the outdoor unit, the indoor unit may also be rotated in order to roughly match an angle or pose at which the outdoor unit has been secured to the window.

At 708, the user may align their eye some distance from a first viewing aperture and prepare to observe light rays redirected through an optical loopback component.

At 710, the user may adjust the alignment of the indoor unit such that light rays entering into a loopback input of the optical loopback component are redirected to a loopback output of the optical loopback component and then to the viewing aperture. In some embodiments, the optical loopback component may be composed of fiber optic tubes. In some embodiments, the optical loopback component may be composed of mirrors or other types of reflective surfaces.

At 712 and 714, the user may repeat steps 708 and 710 on a second viewing aperture. More particularly, once a first viewing aperture has been aligned (as indicated via light rays reaching that viewing aperture), a second viewing aperture may then be aligned to ensure proper alignment. To do this, the user may rotate the indoor unit around the first viewing aperture until light rays originating from a second light source reach the second viewing aperture. It should be noted that some embodiments may only include a single viewing aperture to be aligned to achieve proper alignment of the indoor and outdoor units.

At 716, the user may secure the alignment be securing the indoor unit to the window. As noted elsewhere, the indoor unit may be secured to the window via any suitable securing means, such as a suction cup or adhesive pad. In such cases, once the indoor unit has been properly aligned with the outdoor unit, the user may apply pressure to the indoor unit in order to secure the indoor unit to the window.

### CONCLUSION

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. An electronic appliance comprising:
a first unit configured to couple to a first side of a transparent material, the first unit comprising:
an optical loopback component, the optical loopback component comprising at least a loopback input, a loopback output, and a light redirection component; and
a second unit configured to couple to a second side of the transparent material, the second unit comprising:
a first directional light source, wherein the first directional light source is aligned with the loopback input when the second unit is properly aligned with the first unit; and
a first viewing aperture, wherein the first viewing aperture is aligned with the loopback output when the second unit is properly aligned with the first unit.

2. The electronic appliance of claim 1, wherein the first viewing aperture provides a viewing channel between a first side of the second unit and a second side of the second unit opposite the first side.

3. The electronic appliance of claim 1, wherein light is observable by a user through the first viewing aperture a when the second unit is properly aligned with the first unit.

4. The electronic appliance of claim 1, wherein the transparent material is a window, and the first unit is mounted on an outside surface of the window and the second unit is mounted on an inside surface of the window.

5. The electronic appliance of claim 1, wherein the light redirection component comprises at least one fiber optic tube.

6. The electronic appliance of claim 1, wherein the light redirection component comprises at least one reflective surface, prism, or lens.

7. The electronic appliance of claim 1, wherein the first directional light source comprises a light-emitting diode (LED).

8. The electronic appliance of claim 1, wherein the first unit further comprises:
a wireless power receiver to capture power from a wireless charging signal,
a first power supply coupled to the wireless power receiver to store power; and wherein the second unit further comprises:
a second power supply electronically coupled to a power source; and
a wireless power transmitter to output the wireless charging signal; and
power is wirelessly transmitted from the wireless power transmitter to the wireless power receiver via the wireless charging signal when the first unit and second unit are properly aligned.

9. The electronic appliance of claim 1, wherein the first unit further includes a first optical coupler and the second unit further includes a second coupler, wherein data is transmitted between the first unit and second unit when properly aligned.

10. The electronic appliance of claim 1, wherein at least one additional viewing aperture and additional directional light source may be included in the second unit, and at least one optical loopback component may be included in the first unit.

11. A visual alignment component comprising:
a first optical loopback component in a first unit of an electronic appliance, the first optical loopback component comprising at least a loopback input, a loopback output, and a light redirection component, wherein the first optical loopback component is configured to receive light via the loopback input and redirect the light to the loopback output; and
a first viewing aperture and a first directional light source in a second unit of the electronic appliance, wherein the first directional light source is aligned with the loopback input when the second unit is properly aligned with the first unit; and the first viewing aperture is aligned with the loopback output when the second unit is properly aligned with the first unit.

12. The visual alignment component of claim 11, wherein the first viewing aperture provides a viewing channel between an input on a first side of the second unit and the first viewing aperture directly opposite of the input on a second side of the second unit.

13. The visual alignment component of claim 11, wherein a user will observe light in the first viewing aperture when the second unit is properly aligned with the first unit.

14. The visual alignment component of claim 11, wherein the first unit is mounted on an outside surface of a window and the second unit is mounted on an inside surface of the window.

15. The visual alignment component of claim 11, wherein the light redirection component comprises a fiber optics tube, or at least one reflective surface, prism, or lens.

16. The visual alignment component of claim 11, wherein the first directional light source comprises a light-emitting diode (LED).

17. The visual alignment component of claim 11, wherein:
the first unit further comprises:
a wireless power receiver to capture power from a wireless charging signal; and
a first power supply coupled to the wireless power receiver to store the power;
the second unit further comprises:
a second power supply electronically coupled to a power source; and
a wireless power transmitter to output the wireless charging signal; and
power is wirelessly transmitted from the second unit to the first unit when the first unit and second unit are properly aligned.

18. The visual alignment component of claim 11, wherein the first unit further includes a first optical coupler and the second unit further includes a second coupler, wherein data is transmitted between the first unit and second unit when properly aligned.

19. The visual alignment component of claim 11, wherein more than one additional viewing apertures and directional light sources may be included in the second unit, and more than one optical loopback component may be included in the first unit.
